(19) United States
(12) Patent Application Publication
(10) Pub. No.: US 2009/0109816 A1
(43) Pub. Date: Apr. 30, 2009

(54) OPTICAL DISC APPARATUS AND OPTICAL DISC PROCESSING METHOD

(75) Inventors: Takashi Usui, Yokohama-shi (JP); Kazuo Watabe, Kokohama-shi (JP); Keiichiro Yusu, Yokohama-shi (JP); Chosaku Noda, Yokohama-shi (JP); Kazuto Kuroda, Yokohama-shi (JP); Nobuaki Kaji, Yokohama-shi (JP); Masahiro Saito, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/256,365

(22) Filed: Oct. 22, 2008

(30) Foreign Application Priority Data
Oct. 29, 2007 (JP) 2007-280763

(51) Int. Cl. G11B 7/00

(52) U.S. Cl. 369/47.53; G9B/7

(57) ABSTRACT

According to one embodiment, a calibration section controls an LD driving section so as to carry out test writing on a recording layer of an optical disc using a light pulse having relaxation oscillation, irradiates the test-written area with a reproduction laser beam so as to detect reflected light, and determine write strategy based on the detected result. A recording process is executed on the optical disc by using the light pulse having relaxation oscillation based on the write strategy determined by the calibration section.

### CROSS-REFERENCE TO RELATED APPLICATIONS

This application is based upon and claims the benefit of priority from Japanese Patent Application No. 2007-280763, filed Oct. 29, 2007, the entire contents of which are incorporated herein by reference.

### BACKGROUND

1. Field

One embodiment of the present invention relates to an optical disc apparatus and an optical disc processing method which execute a recording process using relaxation oscillation of a laser beam.

2. Description of the Related Art

In recent years, as recording media which are suitable for recording, reproducing and erasing (repetitive recording) of information, optical discs are widely used. As these optical discs, CD and DVD (digital versatile discs) are generally known. Also, HD DVD and BD (Blu-ray disc) which are obtained by further developing DVD are excellent in recording capacity for recording video and audio (music data).

As a recording method for such optical discs, a method for recording information with higher density using a steep pulse whose recording pulse length is smaller than 1 ns (nanosecond) is developed. This recording method is called as, for example, sub-nano pulse recording method or a recording method using relaxation oscillation.

Jpn. Pat. Appln. KOKAI Publication No. 2002-123963 describes a laser driving method for recording mark strings on an optical disc using relaxation oscillation, and an optical disc apparatus using this method.

This publication describes that mark strings are recorded on an optical disc using both a normal recording pulse and the relaxation oscillation, but does not mention how to determine and how to use a write strategy in this case.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram schematically illustrating a constitution of an optical disc apparatus according to one embodiment of the present invention;

FIG. 2 is a block diagram illustrating a constitution of a semiconductor laser driving circuit of the optical disc apparatus;

FIG. 3 is a flowchart illustrating one example of a calibration process of the optical disc apparatus;

FIG. 4 is a timing chart illustrating examples of respective signals in the case where a 2T mark and a 3T mark of the optical disc apparatus are formed;

FIG. 5 is a timing chart illustrating examples in the case where a 4T mark of the optical disc apparatus is formed;

FIG. 6 is a diagram illustrating one example of a cross-sectional view of an optical disc to be used in the optical disc apparatus;

FIG. 7 is a diagram illustrating one example of a semiconductor laser to be used in a light source of the optical disc apparatus;

FIG. 8A is a diagram illustrating one example of a waveform of a driving current of a semiconductor laser at the time of normal recording;

FIG. 8B is a diagram illustrating one example of an emission waveform of the semiconductor laser at the time of normal recording;

FIG. 8C is a diagram illustrating one example of a waveform of the driving current of the semiconductor laser at the time of generating a relaxation oscillation pulse;

FIG. 8D is a diagram illustrating one example of the emission waveform of the semiconductor laser at the time of generating the relaxation oscillation pulse;

FIG. 9 is a diagram illustrating one example of a measured result of a relaxation oscillation waveform by means of a semiconductor laser when a resonator length is 650 μm;

FIG. 10A is a diagram for explaining an amorphous mark formed by a conventional recording pulse;

FIG. 10B is a diagram for explaining an amorphous mark formed by a short pulse;

FIG. 11A is a diagram for explaining one example of temperature distribution on a recording track in a case of short pulse recording;

FIG. 11B is a diagram for explaining one example of the temperature distribution on the recording track in a case of recording by means of a conventional recording pulse;

FIG. 12 is a diagram illustrating one example of a light pulse waveform at the time of controlling a driving pulse of a semiconductor laser so that three relaxation oscillation pulses are generated;

FIG. 13 is a diagram for explaining a relationship among a driving current of a laser element of PUH, a laser output waveform and a recording mark formed on a recording film;

FIG. 14 is a diagram for explaining a relationship between the laser output waveform and “T1” period;

FIG. 15 is an explanatory diagram illustrating one example of a waveform of a driving current to be given by a semiconductor laser light source;

FIG. 16 is a diagram for explaining a relationship between the laser output waveform and a length of an interval thereof at the time of giving the driving current shown in FIG. 15; and

FIG. 17 is a diagram for explaining one example of a relationship between data (NRZI) to be recorded and a corresponding driving current waveform of a laser diode (LD) in “sub-nano pulse recording”.

### DETAILED DESCRIPTION

Various embodiments according to the invention will be described hereinafter. In general, according to one embodiment of the invention, there is provided an optical disc apparatus comprising: a light source section which irradiates an optical disc with a laser beam; a driving section which supplies a driving current to the light source section; a determining section which controls the driving section so as to carry out test writing on a recording layer of the optical disc using a light pulse having relaxation oscillation, irradiates the test-written area with a reproduction laser beam, and detects its reflected light so as to determine a write strategy based on the detected result; and a recording section which executes a recording process on the optical disc using a light pulse having relaxation oscillation based on the write strategy determined by the determining section.

The laser beam having relaxation oscillation is calibrated so that the write strategy is determined. As a result, the recording process on the optical disc can be securely executed by using the relaxation oscillation of the laser beam with reference to optimum peak current and pulse width. Further, power consumption can be reduced to about ⅕ of conventional one.

The optical disc apparatus according to one embodiment of the present invention is described below with reference to the drawings.

<One Example of the Optical Disc Apparatus According to One Embodiment of the Present Invention>

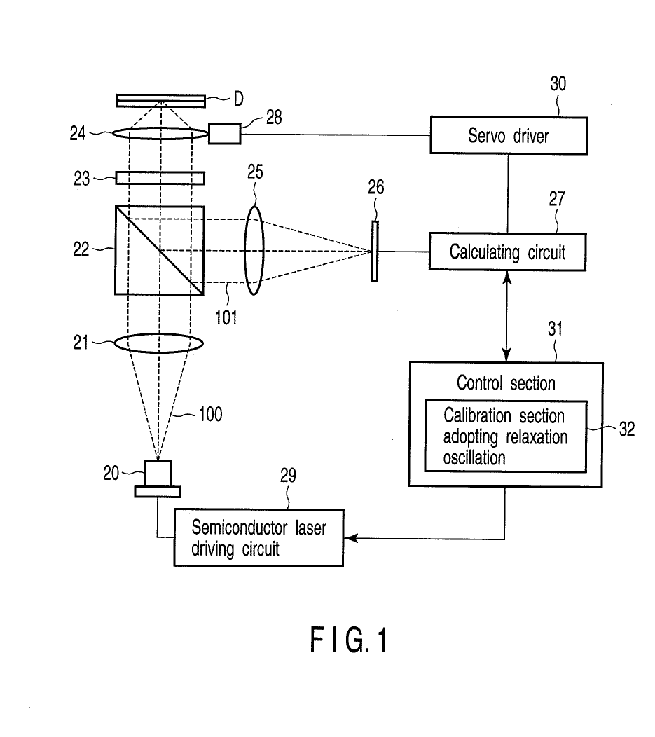

FIG. 1 is a block diagram schematically illustrating a constitution of the optical disc apparatus according to one embodiment of the present invention.

In the optical disc apparatus according to this embodiment, a semiconductor laser light source 20 of short wavelength is used as a light source. A wavelength of its emitted light falls, for example, within a range of 400 nm to 410 nm which is a violet wavelength range.

Emitted light 100 from the semiconductor laser light source 20 is made to be parallel light by a collimating lens 21, and transmits through a polarization beam splitter 22 and a λ/4 plate 23. The light, then, enters an objective lens 24. Thereafter, the light transmits through a substrate of an optical disc D, and is focused onto a target information recording layer. Reflected light 101 reflected from the information recording layer of the optical disc D transmits through a protective layer 2 of the optical disc D, and transmits through the objective lens 24 and the λ/4 plate 23. After the reflected light 101 is reflected from the polarization beam splitter 22, the light 101 transmits through a condenser lens 25 so as to enter a photodetector 26.

A light receiving section of the photodetector 26 is normally divided into a plurality of parts, and currents corresponding to light intensities are output from the light receiving sections, respectively. The output currents are converted into voltages by an I/V amplifier, not shown, and then, the voltages are subject to a calculating process by a calculating circuit 27 so that signals such as an HF signal for reproducing user data information, a focus error signal and a track error signal for controlling a beam spot position on the optical disc D are obtained. The calculating circuit 27 is controlled by a control section 31. The control section 31 includes a calibration section 32 particularly using relaxation oscillation.

The objective lens 24 can be driven to an up-down direction and a disc radial direction by an actuator 28. The objective lens 24 is controlled by a servo driver 30 so as to track an information track on the optical disc D. The optical disc D is a recording disc on which information can be written, and information is recorded therein by the emitted light 100 from the semiconductor laser light source 20. In the semiconductor laser light source 20, a light amount of the emitted light 100 can be controlled by a semiconductor laser driving circuit 29. When information is recorded on the optical disc D, the semiconductor laser light source 20 is controlled so as to emit a relaxation oscillation pulse. The semiconductor laser driving circuit 29 is controlled by the control section 31. The recording pulse when recording information on the optical disc D is described in detail later.

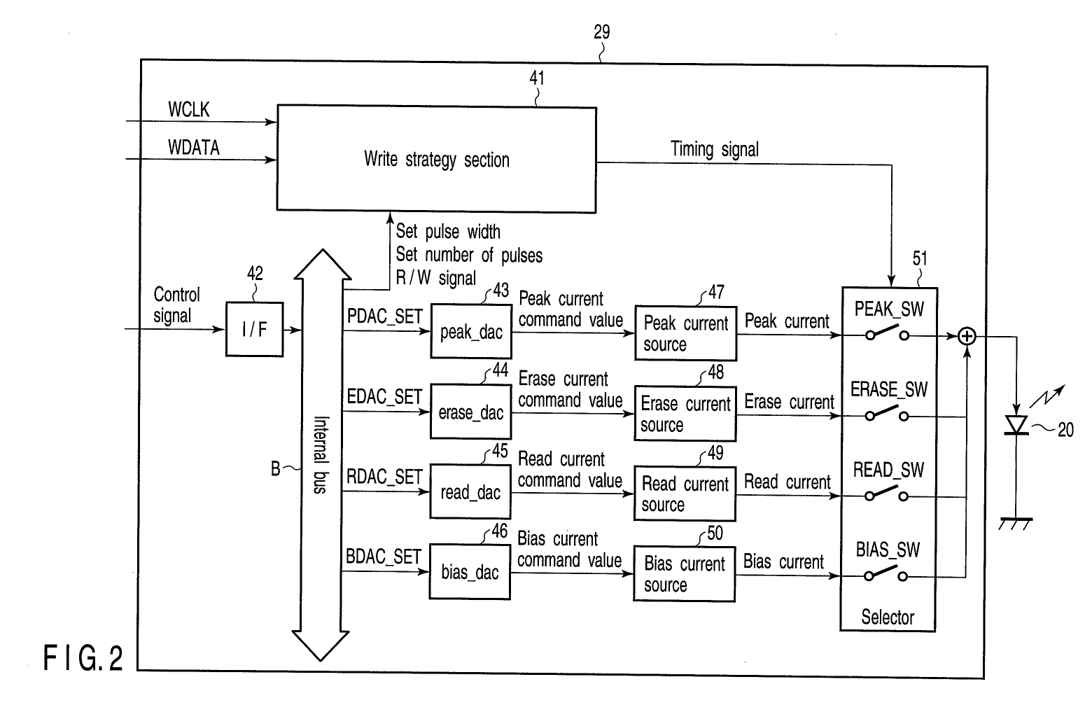

FIG. 2 is a block diagram illustrating a constitution of the semiconductor laser driving circuit of the optical disc apparatus mentioned above.

The semiconductor laser driving circuit 29 has an interface section 42, a write strategy section 41, a peak digital-to-analog converter 43, an erase digital-to-analog converter 44, a read digital-to-analog converter 45, and a bias digital-to-analog converter 46. The interface section 42 receives various signals including a control signal from the control section 31. The write strategy section 41 stores write strategy information to be used at the time of recording a peak current value and a pulse width, and provides a timing signal to a selector 31 according to the write strategy information. A peak current command value is given as a digital signal to the peak digital-to-analog converter 43. An erase current command value is given as a digital signal to the erase digital-to-analog converter 44. A read current command value is given as a digital signal to the read digital-to-analog converter 45. A bias current command value is given as a digital signal to the bias digital-to-analog converter 46.

The semiconductor laser driving circuit 29 further has a peak current source 47, an erase current source 48, a read current source 49, a bias current source 50 and a selector 51. The peak current source 47 receives a peak current command value of an analog value from the peak digital-to-analog converter 43 and supplies a peak current to a subsequent stage. The erase current source 48 receives an erase current command value of an analog value from the erase digital-to-analog converter 44 and supplies an erase current to a subsequent stage. The read current source 49 receives a read current command value of an analog value from the read digital-to-analog converter 45 and supplies a read current to a subsequent stage. The bias current source 50 receives a bias current command value of an analog value from the bias peak digital-to-analog converter 46 and supplies a bias current to a subsequent stage. The respective currents from the current sources are supplied to the selector 51, which selects one from the currents according to a timing signal, and supplies the selected current to the semiconductor laser light source 20 on the subsequent stage. The signal input via the interface section 42 is supplied to the respective sections via an internal bus B.

(Calibration Process)

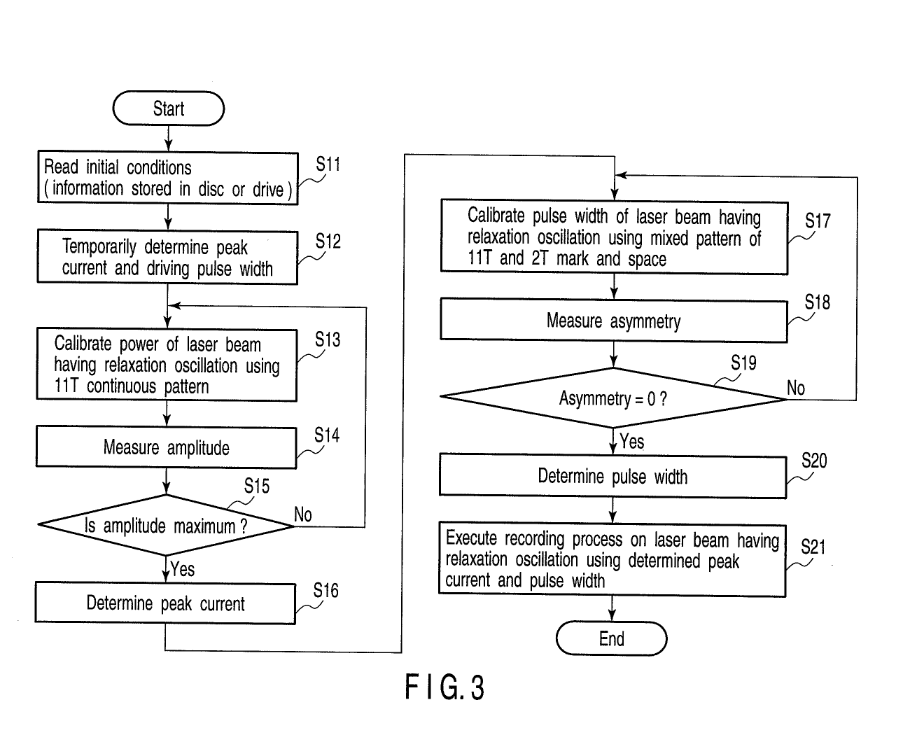

The calibration process for the recording process using the relaxation oscillation of a laser beam of the optical disc according to one embodiment of the present invention is described below with reference to the drawings. FIG. 3 is a flowchart illustrating one example of the calibration process of the optical disc apparatus.

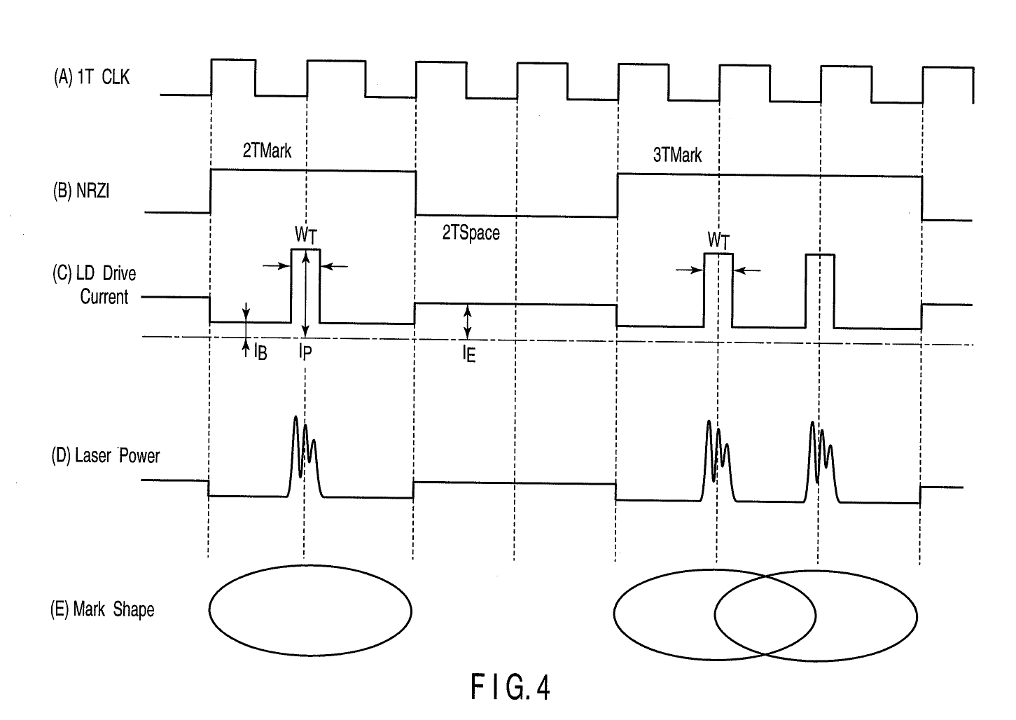

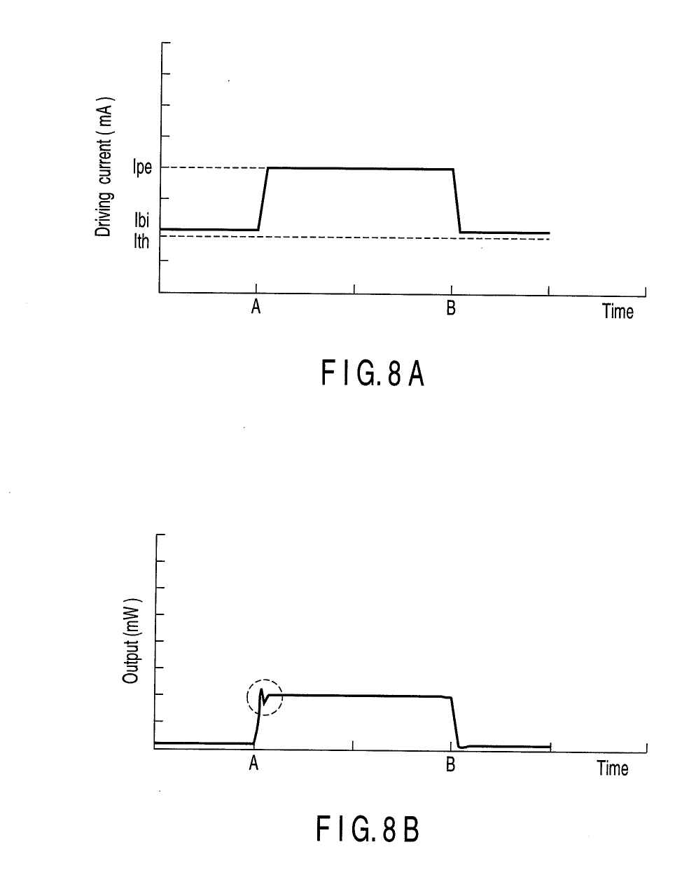

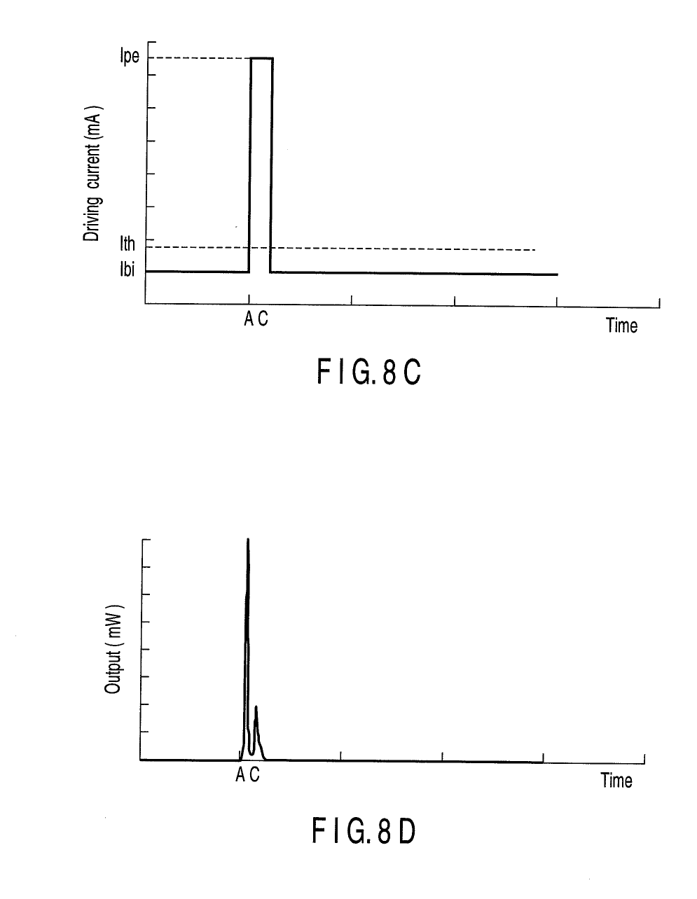

The relaxation oscillation of the laser beam is a transitional oscillation phenomenon of a laser beam power which is generated when the laser driving current abruptly rises from a certain level to a constant level which greatly exceeds a threshold current of laser oscillation as described later with reference to FIGS. 4 and 8A to 8D. In order to execute the recording process using the relaxation oscillation, it is necessary to determine a write strategy such as a suitable level and pulse width of the laser driving current. The calibration section 32 of the control section 31 supplies a control signal to the semiconductor laser driving circuit 29, so as to execute the calibration as follows.

The calibration section 32 reads initial setting conditions prepared in the optical disc D or a servo driver 30 as shown in the flowchart of FIG. 3 (step S11). The calibration section 32 temporarily then determines one set of a peak current and a driving pulse width from five sets of peak currents and driving pulse widths based on the read initial settings (step S12).

The calibration section 32 uses, for space frequency transmission characteristics of an optical pickup head, a signal for recording a long mark for sufficiently obtaining a modulation degree as a recording signal, so as to calibrate the peak current (step S13). The long mark for sufficiently obtaining the modulation degree is representatively 11T, but any one of 6T to 13T can be used.

The mark of this value is test-written on the optical disc D by a laser beam having relaxation oscillation, namely, a relaxation oscillation section. The test-written area is then irradiated with a laser beam for reading, and its reflected light is detected so that the amplitude is measured (step S14). The amplitude is calibrated. An LD driving current and a laser power at this time have waveforms shown in FIG. 4C and FIG. 4D, for example. In FIG. 4, a 2T mark and a 3T mark are shown, but a continuous pattern of 11T (mark and space) is used in this calibration. The peak current is a peak current I_{P} of a write pulse in the LD driving current as shown in FIG. 4C, for example.

This calibration determines whether the detection signal amplitude of the reflected light is maximum by gradually increasing the peak current I_{P} (step S15). The current at the time the amplitude is determined as maximum is determined as a peak current of the write strategy, and is stored in a storage area of the write strategy section 41, for example (step S16).

The calibration section 32 uses a recording signal which includes a shortest length mark and a sufficiently long mark, such as a mixed signal of a mark and a space of 11T (any one of 6T to 13T can be used) and a mark and a space of 2T as the shortest mark length so as to calibrate the pulse width. That is, test writing is carried out on the optical disc D by the laser beam which is emitted by a driving current of the temporarily determined pulse width (W_{T} shown in FIG. 4) and has the relaxation oscillation (step S17). The calibration section 32 emits a laser beam for reading to the test-written area on the optical disc D at step S12, and detects its reflected light (step S18).

The calibration section 32 calculates asymmetry of its reproduction signal, and adjusts the pulse width W_{T} so that the asymmetry becomes about zero (step S19). The pulse width at this time is determined as strategy, and is stored in a storage area of the strategy section 41 or the like (step S20).

The asymmetry may obtain a value expressed as follows. At this time, a reproduction RF signal is allowed to transmit through a high-pass filter, and an amplitude level of a positive side (upper side) is set to A1 (normally, a positive value) based on 0 V, and an amplitude level of a negative side (lower side) is set to A2 (normally, a negative value) based on 0 V in an AC coupled state.

Asymmetry=(A1+A2)/(A1−A2)

Another method for determining a pulse width is now described. A difference between a reproduction signal level in an unrecorded area and an amplitude center level of a reproduction signal of a continuous recording pattern of 11T is set as a first difference. A difference between the reproduction signal level in the unrecorded area and an amplitude center level of a reproduction signal of a continuous recording pattern of the shortest length mark (2T) is set as a second difference. A pulse width with which the first difference is about twice as large as the second difference is searched for so as to be determined as strategy. The pulse width is stored in the storage area of the write strategy section 41 or the like so that the equivalent effect can be obtained.

The write strategy to be used in the recording process using relaxation oscillation is not defined by pulse edge timing of each recording mark length and edge timing compensation values unlike the conventional recording process, by the shortest pulse width W_{T}.

The write strategy which is obtained in such a manner and stored in the write strategy section 41 is read at the time of a data recording process under the control of the control section 31. The recording process using the relaxation oscillation of a laser beam is executed on an optical disc by determining the peak current, the erase current and the like based on the read write strategy (step S21).

Outline of the Recording Process Using Relaxation Oscillation

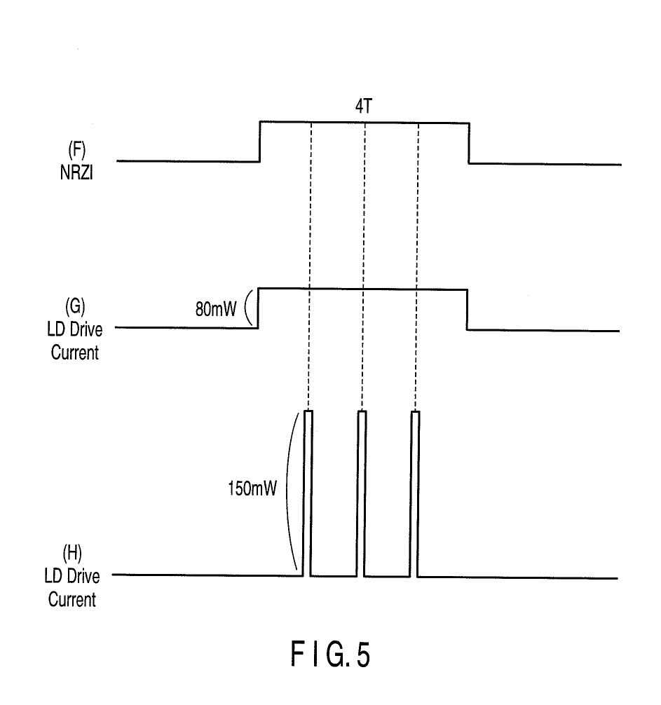

The outline of the recording process using relaxation oscillation is described with reference to FIGS. 4 and 5. FIG. 4 is a timing chart illustrating examples of signals at the time of forming the 2T mark and the 3T mark of the optical disc apparatus. FIG. 5 is a timing chart illustrating examples of the signals at the time of forming the 4T mark of the optical disc apparatus.

When the 2T mark is formed, as shown in FIG. 4C, one current pulse as one example is supplied from the semiconductor laser driving circuit 29 to the semiconductor laser light source 20. The pulse width W_{T}, the peak current I_{P}, the bias current I_{B}, and the erase current I_{E} are shown. When the 3T mark is formed, two current pulses are supplied from the semiconductor laser driving circuit 29 to the semiconductor laser light source 20. The laser beam emitted from the semiconductor laser light source 29 has a steep pulse-shaped power as shown in FIG. 4D, and several oscillation waves, namely, relaxation oscillation can be seen.

In FIG. 5, the following two cases are allowed to be contrasted with each other: a case that a conventional driving current is supplied from the semiconductor laser driving circuit 29 (G), so that a laser beam approximately corresponding to the 4T mark length is emitted, and the 4T mark is formed on the storage layer of an optical disc; and a case that the steep pulse-shaped driving current according to one embodiment of the present invention is supplied (H) so that the steep pulse-shaped laser beam accompanying relaxation oscillation is emitted, and the 4T mark is formed on the storage layer of the optical disc.

The highly important thing is that the relaxation oscillation system according to one embodiment of the present invention enables the recording process equivalent to the conventional method using very low energy which is about ⅕ of the conventional power consumption. For example, in the conventional method, about 300 pJ of energy is required for recording the 4T mark under the conditions that the peak power is 10 mw, the current is 80 mA and the sum of the multi-pulse widths is 30 ns. On the contrary, in the relaxation oscillation system, when three pulses accompanying relaxation oscillation of 20 pJ are used, about 60 pJ of energy is required for recording the 4T mark under the conditions that peak power is 40 mw, the current is 150 mA and the current pulse width is 1.5 ns. That is, the recording of the 4T mark which is equivalent to the conventional system is enabled by very low energy which is about ⅕ of the conventional system.

<Details of the Recording Process Using Relaxation Oscillation>

Specific characteristics of the recording process using relaxation oscillation in the optical disc apparatus mentioned above are now described in detail below with reference to the drawings.

(Optical Disc D)

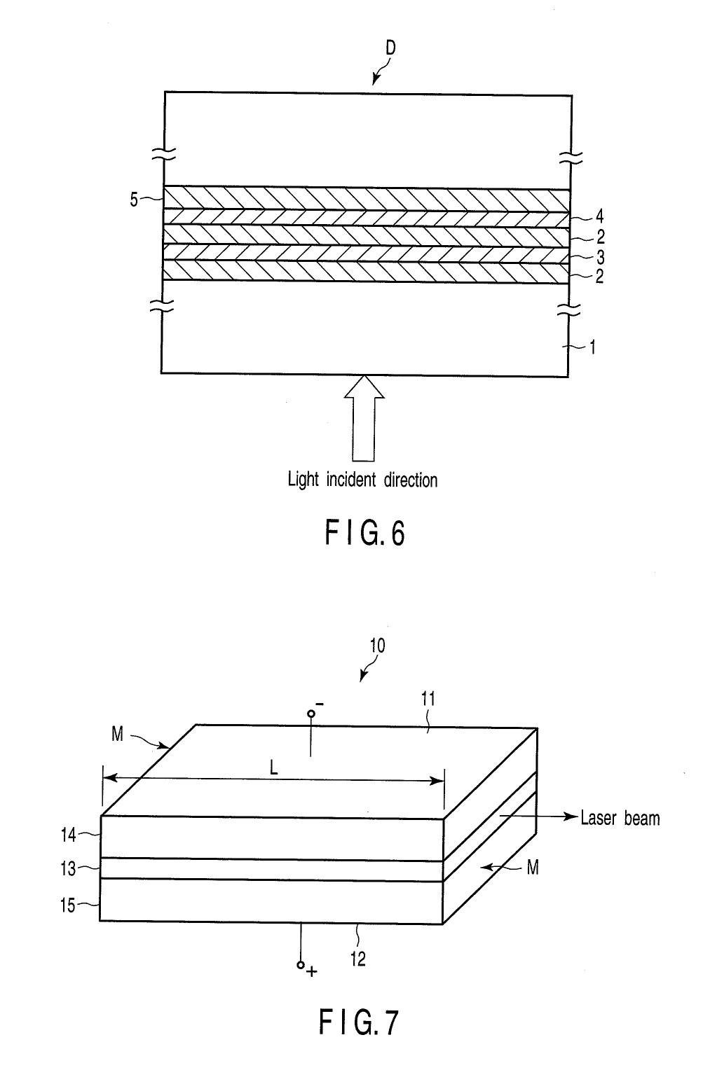

One example of the optical disc D to be used in the optical disc apparatus is described. FIG. 6 illustrates an example of a cross-sectional view of the optical disc D to be used in the optical disc apparatus according to this embodiment. A recording layer 3, for example, as a phase-change recording film is formed on a substrate 1 made of polycarbonate in which a protective layer 2 made of a dielectric body is formed therebetween. Another protective layer 2 made of the dielectric body is further formed thereon, and a conductive reflection layer 4 is further formed thereon. Another substrate 1 made of polycarbonate is formed thereon after an adhesive layer 5 is formed on the layer 4.

From a viewpoint of a whole constitution, the optical disc D is constituted so that two discs where an information recording layer including a recording film is formed on at least one of the substrates are laminated back to back. A thickness of one substrate is, for example, about 0.6 mm, and the whole thickness of the optical disc D is about 1.2 mm.

This embodiment describes an example of the optical disc whose information recording layer is composed of four layers, but the present invention can be applied also to an optical disc whose information recording layer is composed of five layers in which interface layers are provided on and under the recording layer 3. This embodiment describes the case where the number of the information recording layer is one, but the present invention can be applied also to an optical disc having the two or more information recording layers. Further in this embodiment, the disc-shaped optical disc is used as a recording medium, but the present invention can be applied also to, for example, a card-shaped recording medium.

(Semiconductor Chip Section as One Part of the Semiconductor Laser Light Source)

A semiconductor chip section as one part of the semiconductor laser light source to be used in the optical disc apparatus is described in detail below with reference to the drawings. FIG. 7 illustrates an example of the semiconductor laser light source 20 to be used as a light source in the optical disc apparatus according to this embodiment.

FIG. 7 illustrates only a semiconductor chip section 10 to be a semiconductor laser illuminator. Normally, the semiconductor chip section 10 is fixed to a metal block to be a heat sink, and composed of a base material, a cap with paned window, and the like.

The description uses only the semiconductor chip section 10 relating directly to the laser beam emission. The semiconductor chip section 10 is a minute block whose thickness (up-down direction in plane in the drawing) is about 0.15 mm, length (L in the drawing) is about 0.5 mm, lateral width (widthwise direction in the drawing) is about 0.2 mm, as one example. The laser chip has an upper end electrode 11 and a lower end electrode 12, and the upper end electrode 11 is a − (minus) electrode and the lower end electrode 12 is a + (plus) electrode.

A center active layer 13 emits a laser beam, and an upper cladding layer 14 and a lower cladding layer 15 are formed with the active layer 13 formed therebetween. The upper cladding layer 14 is an n-type cladding layer where many electrons are present, and the lower cladding layer 15 is a p-type cladding layer where many electron holes are present.

When a voltage is applied between the lower end electrode 12 and the upper end electrode 11 in a forward direction, namely, from the lower end electrode 12 to the upper end electrode 11, the many electron holes and electrons excited in the active layer 13 are recoupled, and light corresponding to energy which is lost at that time is emitted. A material is selected so that refraction indexes of the upper cladding layer 1 and the lower cladding layer 15 become lower than a refraction index of the active layer 13 (as one example, lowered by 5%). A light wave is such that the light generated in the active layer 13 reflects from a boundary between the upper and lower cladding layers 14 and 15 and simultaneously advances to right and left in the active layer 13 in the drawing.

End surfaces of the right and left in the drawing are mirror surfaces M, and the active layer 13 itself forms a light resonator. The light wave which advances right and left in the active layer 13 and reflects from the mirror surfaces at the right and left ends is amplified in the active layer 13, and is finally discharged as a laser beam from the right end (and left end) in the drawing. At this time, the resonator length of the semiconductor laser light source 20 is a length L in the right-left direction in the drawing.

An outgoing waveform of the semiconductor laser light source 20 is controlled by a driving current generated by the semiconductor laser (laser diode [LD]) driving circuit 29. A state that a recording pulse to be used for recording on the optical disc D is generated by the driving current of the semiconductor laser driving circuit 29 is described with reference to FIGS. 8A to 8D.

(Recording Process Using Relaxation Oscillation)

The recording process using the relaxation oscillation of the laser beam according to one embodiment of the present invention is described in detail below with reference to the drawings. FIGS. 8A and 8B illustrate normal semiconductor laser driving current and semiconductor laser outgoing waveform. FIGS. 8C and 8D illustrate semiconductor layer driving current and semiconductor laser outgoing waveform at the time of generating the relaxation oscillation pulse.

The driving current is controlled to 2 levels of a bias current Ibi and a peak current Ipe shown in FIGS. 8A and 8C. In some cases, the bias current is further segmentalized into two levels or three levels to be controlled, but for easy description, the case of one level of the bias current Ibi and one level of the peak current Ipe are described.

When a normal recording pulse is generated, the semiconductor laser driving circuit 29 generates the bias current Ibi set to a level slightly higher than a threshold current Ith for starting laser oscillation as shown in FIG. 8A, so as to drive the semiconductor laser light source 20. The peak current Ipe for obtaining a desired peak power is then applied at time A, and after the peak current Ipe is applied for constant time, the current of the semiconductor laser light source 20 is reduced to the bias current Ibi again at time B. Change in the emitted light intensity of the semiconductor laser light source 20 over time at this time is shown in FIG. 8B.

As shown in FIG. 8B, the emitted light intensity until the time A at which the semiconductor laser light source 20 is driven by the bias current Ibi has a very low power with which the data recording on the optical disc D cannot be executed. However, when the peak current Ipe is applied, the intensity is increased to the recording power, and this level is maintained until the driving current is reduced to the level of the bias current Ibi at time B. After the time B, the emitted light intensity becomes again a low power. The semiconductor laser light source 20 is therefore controlled so that the recording pulse is emitted for a period from the time A to time B.

The emitted light intensity is observed more specifically. When the intensity is increased to the recording power at the time A, a state that the intensity is instantaneously increased and then reduced until a stationary recording power becomes stable can be observed (circle portion indicated by a broken line in the drawing). This is a current waveform by means of the relaxation oscillation of the semiconductor laser light source 20, and when a normal recording pulse is generated, the semiconductor laser light source 20 is controlled so that the relaxation oscillation becomes as small as possible.

The relaxation oscillation is a transitional oscillation phenomenon which is generated when the driving current abruptly rises from a certain level to a constant level which exceeds the threshold current in such a semiconductor laser. The relaxation oscillation becomes low every time the oscillation repeats, and the oscillation stops with time.

In the optical disc apparatus according to this embodiment, this relaxation oscillation is positively used for recording. When the relaxation oscillation is used as the recording pulse, as shown in FIG. 8C, the semiconductor laser driving circuit 29 firstly generates the bias current Ibi set to a lower level than the threshold current Ith of the semiconductor laser light source 20, so as to drive the semiconductor laser light source 20.

Thereafter, at the time A, the driving current is abruptly increased to the peak current level Ipe at earlier rise time than the time of the normal recording pulse generation. After the time shorter than the time of the normal recording pulse generation, the current is reduced to the bias current Ibi again at time C. A time change in the emitted light intensity of the semiconductor laser light source 20 in time at this time is shown in FIG. 8D.

As shown in FIG. 8D, the semiconductor laser light source 20 does not start laser oscillation until the time A at which the semiconductor laser light source 20 is driven by the bias current Ibi lower than the threshold current Ith, and the semiconductor laser light source 20 emits ignorable light as a light-emitting diode. Thereafter, according to abrupt application of a current at the time A, the relaxation oscillation is started, and the emitted light intensity abruptly increases. The light emission by means of the relaxation oscillation is maintained until the time C which is when the applied current is returned to again the threshold current or less. In this example, the time C comes at timing at which a second-cycle pulse of the relaxation oscillation is generated, and the recording pulse generation is ended.

The pulse by means of the relaxation oscillation has a characteristic such that the emitted light intensity increases for very shorter time than the normal recording pulse and is reduced at constant cycle determined by the constitution of the semiconductor laser. Therefore, a short pulse which has short rise and fall time and strong peak intensity that cannot be obtained in the normal recording pulse can be obtained by using the pulse by means of the relaxation oscillation as the recording pulse.

The following relationship holds between the resonator length L and the relaxation oscillation cycle T as a generally-known relationship.

T=k·{2nL/c} (1)

where k, n and c represent a constant number, a refraction index of the active layer of the semiconductor laser, and a light speed (3.0×108 (m/s)), respectively. Therefore, it is found that a proportional relationship holds between the resonator length L and the relaxation oscillation cycle T, thus the relaxation oscillation pulse width.

As a result, when the relaxation oscillation pulse width is desired to be long, the resonator length L may be made to be long. When the relaxation oscillation pulse width is desired to be short, the resonator length L may be made to be short. That is, the relaxation oscillation pulse width can be controlled by the resonator length L.

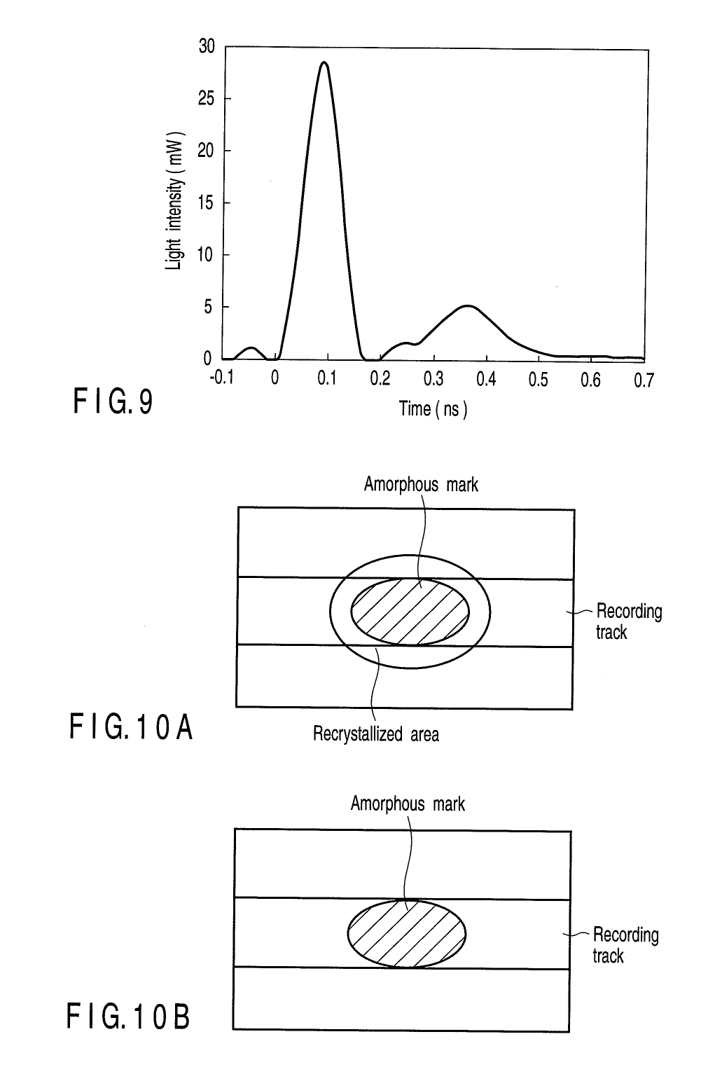

FIG. 9 illustrates measured results of the relaxation oscillation waveform by means of the semiconductor laser with the resonator length L of 650 μm. It is found that the relaxation oscillation pulse width is 81 ps in full width at half maximum. From the above equation (1), the proportional relationship holds between the resonator length L and the relaxation oscillation pulse width. For this reason, the following relationship can be obtained as a conversion equation of the resonator length L of the semiconductor laser and a relaxation oscillation pulse width (FWHM) Wr to be obtained.

Wr(ps)=L(μm)/8.0(μm/ps) (2)

The data recording on an optical recording medium in the optical disc apparatus according to this embodiment is described below. The optical disc D is a rewritable disc such as DVD-RAM, DVD-RW, HD DVD-RW or HD DVD-RAM, and a phase-change material is used for the recording layer. On the phase-change optical disc, data bit is recorded and erased by controlling the intensity of a pulse-shaped laser beam focused on the recording layer.

(The Recording Process By Means of Relaxation Oscillation Viewed from Formation of Amorphous Mark)

The recording process by means of the relaxation oscillation viewed from the formation of an amorphous mark is described in detail below with reference to the drawings. FIG. 10A is a diagram for explaining an amorphous mark formed by a conventional recording pulse. FIG. 10B is a diagram for explaining an amorphous mark formed by a short pulse.

The recording means formation of an amorphous mark in an area of the recording layer initialized into a crystal state. The amorphous mark is formed by melting and then rapidly cooling the phase-change material. In order to realize this, it is necessary to condense a comparatively short pulse-shaped laser beam of high power on the phase-change recording layer and increase a local temperature to a temperature which exceeds a fusing point Tm of the phase-change material and cause local fusing. Thereafter, when the recording pulse is discontinued, the melted local area is rapidly cooled, and a solid amorphous mark through fusing-rapid cooling steps is formed.

On the other hand, the recorded data bit is erased by recrystallizing the amorphous mark. The crystallization is realized by local annealing. When the laser beam is condensed on the recording layer and is controlled to a level slightly lower than the recording power, the local temperature of the phase-change recording layer is increased to crystallization temperature Tg or more, and maintained at a temperature lower than the fusing point Tm.

At this time, the amorphous mark can be phase-changed into the crystallized state by maintaining the local temperature between the crystallization temperature Tg and the fusing point Tm for constant time. In such a manner, the recording mark can be erased.

The time for which the temperature is maintained between the crystallization temperature Tg and the fusing point Tg which is required for crystallization is called as crystallization time. In order to reproduce the recorded data bit, a DC laser beam with a low power which prevents the phase change of the recording layer, namely, a reproduction power is emitted to the information recording layer.

In the optical disc apparatus according to this embodiment, a short pulse such as a relaxation oscillation pulse is used as the recording pulse to be used for recording a data bit. When the amorphous mark formed by the conventional recording pulse is formed via the fusing-rapid cooling steps of the phase-change material, as shown in FIG. 10A, a recrystallized circular area (recrystallized ring) is generated on a peripheral edge of the amorphous mark.

The area which is once fused on the peripheral edge of the amorphous mark is kept in the temperature range from the crystallization temperature Tg and the fusing point Tm at the cooling step for more than the crystallization time, so as to be recrystallized. This has an effect that the size of the amorphous mark is decreased (self-sharpening effect) as a result. However, this occasionally causes jitter (fluctuation) of a reproduction signal at the peripheral edge of the mark, thermal interference of adjacent marks on a track, and partial erase (cross erase) of a mark formed on an adjacent track.

On the other hand, the amorphous mark formed by a short pulse such as the relaxation oscillation pulse of the optical disc apparatus according to this embodiment does not generate a recrystallized ring on the peripheral edge of the amorphous mark as shown in FIG. 10B. This is because, the phase-change layer is fused just after the emission of the laser beam, and the emission is ended before the fused area significantly spreads to the peripheral edge due to heat conduction by emitting the laser beam of high power by the short pulse for short time, so that only the fused portion just after the emission of the laser beam is made to be an amorphous mark.

The amorphous mark which does not cause the recrystallized ring due to the short pulse has advantages such that the jitter of the mark peripheral edge is reduced, a mark deformation and an edge shift due to thermal interference of adjacent marks on the track do not occur, and cross erase of a mark formed on an adjacent track does not occur.

The recording using the short pulse has an advantage such as the quality improvement of the recording mark. Apart from that, since the mark can be recorded in short time, it goes without saying that the recording using the short pulse is suitable for the recording at a high transmission rate.

In the optical disc, as capacity is increased, the high transmission rate is strongly demanded. A double-speed specification based on a standard one-times speed (linear speed: 6.61 m/s) is already published even for HD DVD-R and HD DVD-RW. From here on, high speeds such as four-times speed and eight-times speed are expected.

In order to achieve the high transmission rate, it is necessary to record a recording mark at a high speed, namely for short time. On a phase-change disc, this means that an amorphous mark is recorded by a short pulse. For example, in eight-times speed HD DVD, a channel clock rate becomes 518.4 Mbps, and the time corresponding to one-channel bit is 1.929 ns.

The pulse width required for the short pulse recording in the optical disc apparatus according to this embodiment is a pulse width which does not cause a recrystallized ring at the time of forming an amorphous mark. The area to be the recrystallized ring at the time of forming an amorphous mark is an area which is once fused on the amorphous mark peripheral edge as described above, namely, an area whose temperature exceeds the fusing point of the phase-change material. At this time, only the area whose temperature slightly exceeds the fusing point is recrystallized.

This is because the area whose temperature is raised to greatly exceed the fusing point has a large gradient of temperature reduction, and is comparatively rapidly cooled so as to be amorphous. This is because as is clear from a well-known relationship (Fourier's heat conduction rule) q=K·δT/δx between temperature gradient δT/δx and heat flow rate density q (W/m2), as the temperature gradient is larger, the heat flow rate from a high-temperature area to a low-temperature area becomes larger. In the above formula, K(W/m·K) represents heat conductivity, and x represents a distance of a heat conducting direction on an interface having temperature difference (normal vector direction of the interface).

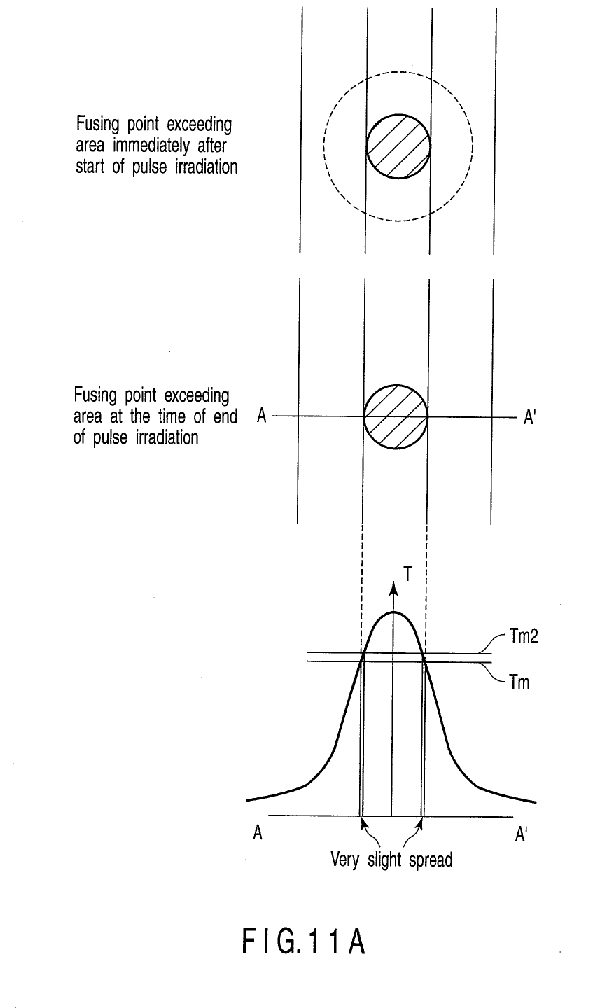

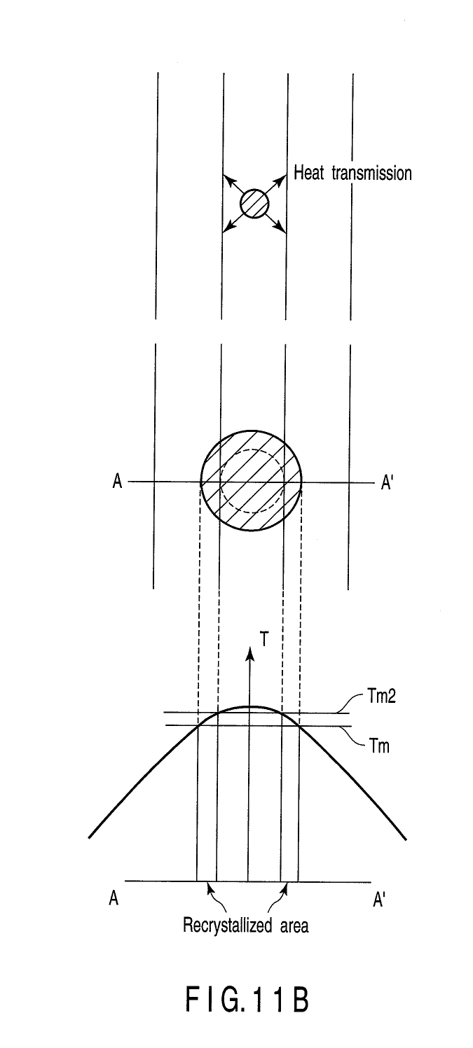

In the case of the short pulse recording, a laser beam of high power is emitted so that the temperature of the optical spot center exceeds the fusing point just after the emission of the laser beam. FIGS. 11A and 11B are diagram for explaining temperature distributions on the recording track. Upper columns in FIGS. 11A and 11B represent the temperature distribution in a fusing point exceeded area on the track just after the emission of the recording pulse, middle columns represent the temperature distribution in a fusing point exceeded area at the time of end of the recording pulse, and lower columns represent the temperature distribution in cross sections taken along line A-A′ of the middle columns.

FIG. 11A illustrates the case of the short pulse recording, and FIG. 11B illustrates the case of recording using a conventional recording pulse. The laser peak power at the time of the recording using the short pulse in FIG. 11A is stronger than the laser peak power at the time of the recording using the conventional pulse in FIG. 11B. Originally, the recording beam spot (area shown by a broken line in FIG. 11A) moves in an up-down direction in the drawing during the pulse emission, but in this example, it does not move for convenience of the description.

In any cases of the recording pulses, the area whose temperature exceeds the fusing point on the optical beam spot center is widened due to heat transfer during just after the pulse emission to the end of the pulse. In the case of the short pulse, however, since the pulse emission time is short, this area is seldom widened.

In the case of the short pulse recording, the temperature distribution on the cross section including the optical spot center at the time of the end of the pulse is approximately a Gaussian distribution, and the temperature gradient is abrupt before and after the interface between not less than the fusing point to not more than the fusing point. For this reason, the area to be recrystallized, namely, the area whose temperature slightly exceeds the fusing point (in the drawing, the area having a temperature between the fusing point Tm and the temperature Tm2) is seldom widened in a planar direction. Therefore, when the laser power becomes 0 for time at which the enlargement of the area having not less than the fusing point on the optical spot center due to heat transfer is ignorable, the recrystallized ring is limited to a very narrow area.

On the other hand, in the case of the mark formation using the conventional recording pulse, since a comparatively low power is emitted for long time, the area whose temperature exceeds the fusing point on the optical spot center is gradually enlarged (from the upper column to the middle column in FIG. 11B). At this time, the temperature distribution on the cross section including the optical spot center is no longer the Gaussian distribution, and has a shape with a more gentle temperature gradient (lower column in FIG. 11B).

For this reason, the area to be recrystallized is comparatively greatly widened in the planar direction. The broken line in the middle column in FIG. 11B represents a recrystallization limitation, and an inside of this broken line is an area to be an amorphous mark. The conventional recording pulse causes a large recrystallized ring at the time of forming a mark.

It is considered that the width of the recrystallized ring in the planar direction is approximately similar to a diffusion distance of the fusing point area in the planar direction for a pulse emitting period. When a general phase-change material has heat conductivity K of 0.005 J/cm/s/° C., and specific heat C of 1.5 J/cm3/° C., the heat diffusion distance within the pulse emission time can be estimated. It is considered that a heat is diffused by a distance L (=(Kt/C)1/2) for time t. For this reason, in order to limit the area of the recrystallized ring to a range which is not more than 10% of a shortest mark length of 0.204 μm of HD DVD-RW, namely, limit within a range of not more than 10.2 nm in one direction, the pulse emission time is 0.44 ns. This is the pulse width which is required for the short pulse recording.

As described above, Equation (2) is obtained as the relationship between the resonator length L of the semiconductor laser and the relaxation oscillation pulse width Wr to be obtained. For this reason, it is necessary for the short pulse recording to use the pulse width of not more than 440 ps, namely, use the semiconductor laser whose resonator length is not more than 3520 μm.

Furthermore, from a viewpoint of the reduction in the recrystallized ring, as the shorter pulse mission time is satisfactory, but actually it is difficult to give energy for raising the temperature of the phase-change material to not less than the fusing point. That is, it is necessary to emit a very high power for short time. Therefore, in practice, it can be considered that the pulse emission time should be not less than about 50 ps. This corresponds to that a semiconductor laser having resonator length of not less than 400 μm is necessary according to the relationship in Equation (2).

As is clear from Equation (2), when the relaxation oscillation pulse is used for information recording on the optical disc D and the resonator length of the semiconductor laser light source 20 to be used in the optical disc apparatus is determined, the relaxation oscillation pulse width is uniquely determined. When the pulse width is short as described above, a high-power pulse is emitted so that the temperature of the phase-change material is raised to not less than the fusing point. However, even when a highest power pulse of the semiconductor laser light source 20 is emitted, the temperature of the phase-change material does not occasionally reach not less than the fusing point. In this case, it is useful that the relaxation oscillation pulse is emitted at a plurality of times.

Three Generated Relaxation Oscillation Pulses

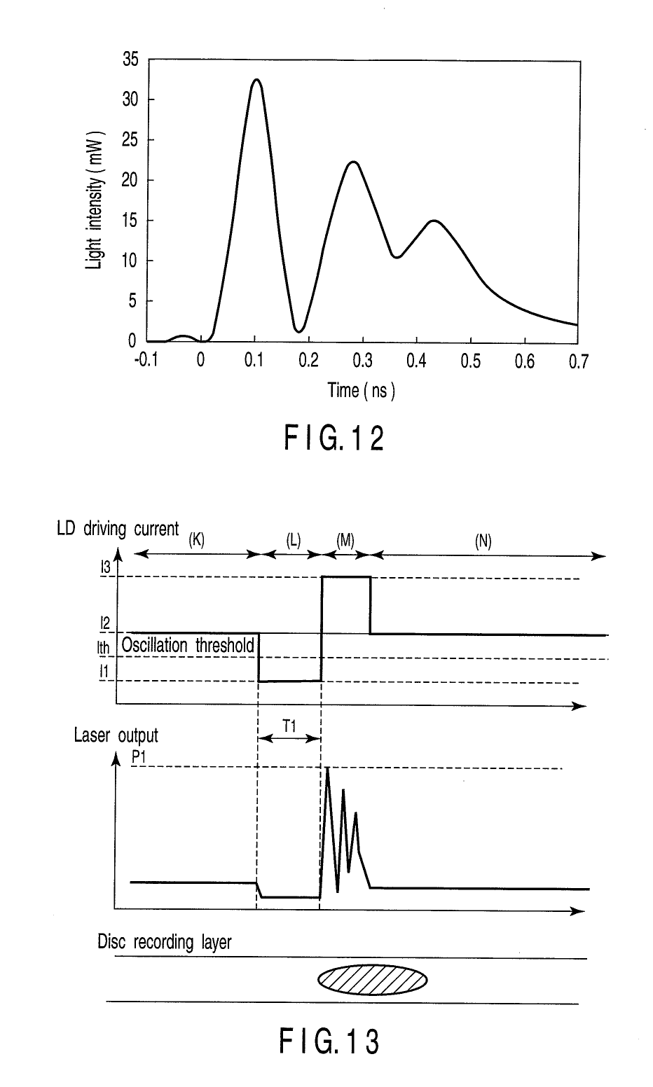

FIG. 12 illustrates a light pulse waveform when the driving pulse of the semiconductor laser light source 20 is controlled so that three relaxation oscillation pulses are generated. When the three relaxation oscillation pulses are generated, the irradiation energy due to the pulse (time integration value due to the pulse in the drawing) increases. As a result, the temperature of the phase-change material can be raised to not less than the fusing point. However, as is clear from FIG. 12, the intensities of the second and third pulses are gradually reduced in comparison with the first relaxation oscillation pulse. For this reason, it is not much effective to emit more pulses.

In the optical disc apparatus which records data in an optical recording medium using the relaxation oscillation pulse of the semiconductor laser light source 20, the number of the relaxation oscillation pulses should be increased or decreased according to the resonator length of a laser. Also when a semiconductor laser whose rated capacity is low is used, it is effective to use a plurality of relaxation oscillation pulses.

<Stabilization of the Recording Pulse Length by Adjusting Driving Current>

Stabilization of the recording pulse length by the adjustment of a driving current is described below as another embodiment. In this embodiment, the pulse width of a laser beam of sub-nano order generated accompanying with relaxation oscillation, namely, the recording pulse length is stabilized. As a result, recording density can be improved.

FIG. 13 is a diagram for explaining a relationship among the driving current of a laser element, a laser output waveform and a recording mark formed on the recording film.

When a focal point of the laser beam on the recording film of the optical disc D is in a place where a recording mark is not formed (K), the power of the laser beam emitted from the semiconductor laser light source 20 is controlled to a reproduction power in order to read position information on the optical disc and servo. That is, a driving current whose level is I2 larger than a driving current threshold Ith for starting laser oscillation is supplied to the semiconductor laser light source 20.

In an interval (M), the laser driving current I3 larger than I2 is supplied to the semiconductor laser light source 20, so that a relaxation oscillation pulse laser beam which reaches the maximum value P1 is output.

In an interval (L) of time T1 just before the interval (M) for which the relaxation oscillation pulse light is output, a laser driving current I1 smaller than the threshold Ith is supplied to the semiconductor laser light source 20.

The laser driving current after the end of the relaxation oscillation, namely, in an interval (N) again becomes the reproduction current I2 higher than the threshold Ith.

That is, in the present invention that information is recorded on the optical disc D by using a steep pulse laser obtained by the relaxation oscillation, an average value of the laser power necessary at the time of information recording is occasionally smaller than an average value of the laser power (reproduction power) required for information reproduction. When the average laser power fluctuates, the temperature of the semiconductor laser light source 20 changes, so that the threshold current thereof also fluctuates.

Such a temperature change is caused even when the uniform currents are supplied to the semiconductor laser light source 20, and the threshold before and after the temperature change fluctuates so that the laser intensity is changed. It is desirable for recording a satisfactory mark on the recording film of the optical disc D that such a change in the threshold is not caused.

In order to avoid such a problem, it is desirable to make the average powers of the lasers for reproduction and recording approximately equal. As to the average powers of the lasers for recording and reproduction, when a first average power (A) to be used for reproduction and a second average power (B) to be used for recording fall within a range expressed by the following formula:

0.8<A/B<1.2

an influence of the temperature change can be generally ignored. The light emission power of PHU is adjusted so that the above formula is satisfied.

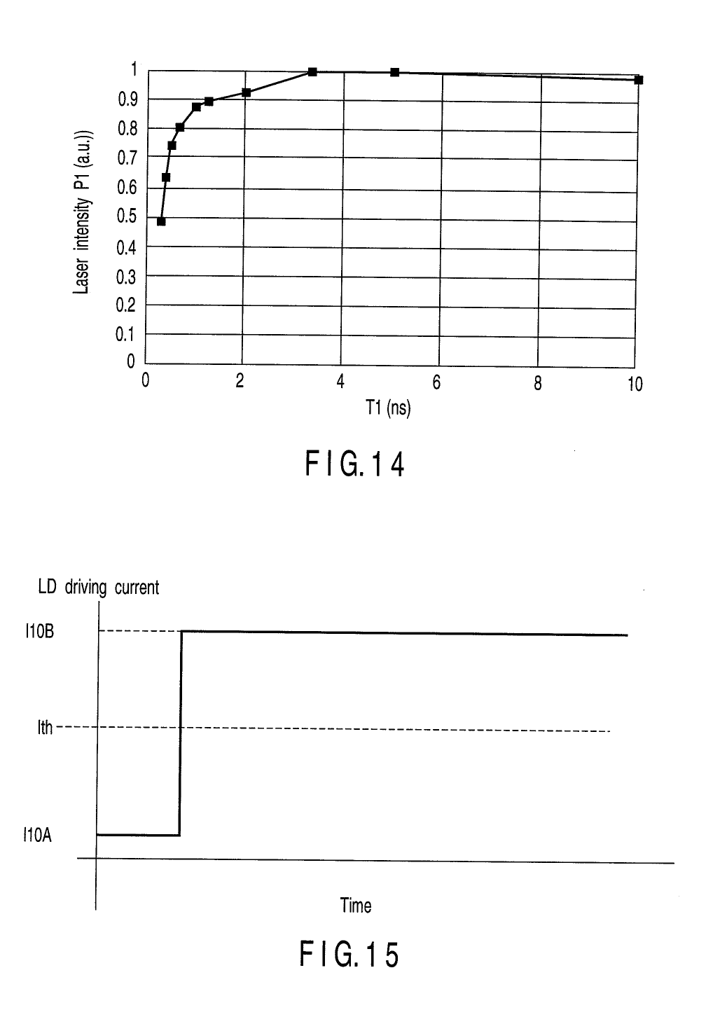

FIG. 14 illustrates a relationship between time T1 of the interval (L) where the current to be supplied to the semiconductor laser light source 20 is set to I1 and the peak power P1 of the relaxation oscillation. The semiconductor laser light source 20 generates a laser beam with wavelength of 405 nm, the resonator length is 800 μm, and the laser oscillation threshold is 35 mA. The driving current sharply increases from 20 to 120 mA at rise time 150 ps.

The relaxation oscillation is a transitional oscillation phenomenon which is caused when the driving current abruptly increases from a certain level to a constant level which greatly exceeds the threshold current in the semiconductor laser, as described above. Therefore, in order to use the relaxation oscillation as a recording pulse, it is essential that the driving pulse width is stable. When the time T1 is short, the peak power P1 of the laser generated by the relaxation oscillation is low, and it is verified that as the time T1 becomes longer, the peak power P1 becomes about 2.2 times as high as the stationary oscillation power. The laser power, then, converges, but in this embodiment, the laser intensity after the convergence of the relaxation oscillation is 0.45×P1.

When the peak power P1 of the head of the relaxation oscillation is high, the total recording energy becomes lower than the recording using the stationary power oscillation. A recording mark is recorded on the optical disc by thermal recording (amount of a heat energy supplied as a laser beam). In normal recording waveform with which a mark is recorded for a longer time than the present invention, heat is diffused during the laser irradiation. On the contrary, in the relaxation oscillation according to this embodiment, since a high power is emitted for short time of not more than 1 ns, the heat diffusion is small at the time of the laser irradiation. That is, in this embodiment, the heat diffusion time is about 1 ns. For this reason, the recording energy which is obtained by temporarily integrating the power in the recording method using the relaxation oscillation is lower than that in the normal recording method where the irradiation time greatly exceeds 1 ns. When the peak power Pi of the head relaxation oscillation is 2.2 times as high as the stationary laser intensity, the recording energy is reduced to about 40% of a normal stationary oscillation laser. As a result, the consumption energy of a pickup head is reduced, and an increase in the temperature of the pickup head can be repressed. Optical elements such as an objective lens and a mirror of the pickup head are deformed by heat expansion due to increased temperature, so that a spot diameter focused on the objective lens becomes large, and the size of a mark to be recorded becomes large. However, when the recording is executed by using the relaxation oscillation, the rise in temperature can be suppressed, therefore, such a problem can be reduced.

Particularly such an effect that the recording energy becomes lower than the normal laser irradiation is noticeably seen when the power P1 is two times as high as the stationary laser. Therefore, when a mark is recorded by using the relaxation oscillation, the time T1 is desirably not less than 1 ns which is 90% of a value at which the power P1 is saturated.

When the time T1 is not less than 3 ns, the laser power becomes approximately equal to a saturation power, and it is verified that an influence on the laser power does not likely exist when the time T1 is more than 3 ns. Therefore, it is more desirable that the time T1 is not less than 3 ns.

The rise time Tr and the fall time Tf of the current to be supplied from the semiconductor laser driving circuit 29 to the semiconductor laser light source 20 (the time required for fluctuation of the maximum current flowing in the semiconductor laser light source 20 from 10% to 90% and 90% to 10%) are about 150 ps for each after all the capacitances of the semiconductor laser light source 20, the semiconductor laser driving circuit 29, and wiring, not shown, from the semiconductor laser driving circuit 29 to the semiconductor laser light source 20, and a dielectric coefficient are taken into consideration. In order to generate a suitable level of the relaxation oscillation, it is useful to set the time T1 to not less than Tf+0.87 ns. That is, when Tf is 150 ps, T1 is preferably not less than 1000 ps.

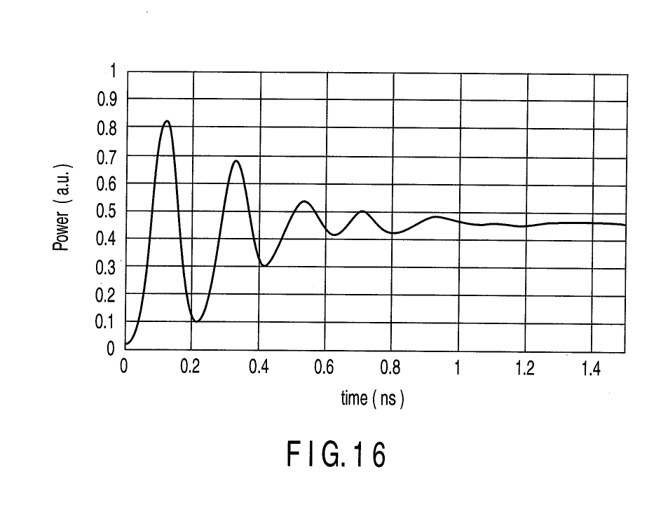

FIG. 15 illustrates one example of the driving current to be given to the semiconductor laser light source. FIG. 16 illustrates a waveform of a laser power to be output from the semiconductor laser light source 20 when the driving current shown in FIG. 15 is applied to the semiconductor laser light source 20.

In FIG. 15, the current flowing in the semiconductor laser light source 20 is abruptly increased from a current I10A of not more than a laser oscillation threshold Ith to a current I10B of not less than the threshold Ith, and thereafter, this current is maintained. In this case, a laser waveform shown in FIG. 16 is obtained. That is, after four to five relaxation oscillations are generated for constant time, the laser power becomes stationary output laser oscillation.

When the resonator length of the semiconductor chip section 10 in the semiconductor laser light source 20 is 800 μm, and the peak power P1 is “1” as shown in FIG. 16, the time for convergence to 0.45×P1 is about 1 ns (1.5 ns, even when the whole range of FIG. 16 is defined as the relaxation oscillation). The number of the relaxation oscillations generated until the convergence of the relaxation oscillation does not depend on the resonator length of the semiconductor laser light source 20. Meanwhile, since the cycle of the relaxation oscillators is proportional to the resonator length, the time until the convergence of the relaxation oscillation is Lt/800 (ns) with respect to the resonator length Lt (μm).

In the case of the recording using both the relaxation oscillation and the stationary oscillation, the quality of a mark is deteriorated further than the case using only the relaxation oscillation. This is because the erase area around the mark spreads. In order to prevent such a problem, it is desirable that the recording pulse width is smaller than the time for which the relaxation oscillation shifts to the stationary state.

Therefore, when the resonator length is 800 μm, the recording pulse length, namely, the length (current pulse width) of the interval (M) in FIG. 13 is suitably set to a length shorter than 1500 ps (1.5 ns).

In the “sub-nano pulse recording” described above, a laser is emitted with the laser emission time falling below 10% (1% to 10%) in a recording mark string to be recorded on the optical disc (information recording medium). For this reason, an average value of the power of the laser beam at the time of recording occasionally falls below the power for reproduction.

On the other hand, some optical discs have a reflectance difference between a mark portion and a space portion which is lower than a normal one depending on materials of recording layers. For this reason, in order to improve an apparent contrast, recording media in which reflectance of a mark portion or a space portion is reduced to about 2% are developed.

When the recording method adopting sub-nano pulse is applied to the information recording on such a recording medium, an average amount of light returning to a photodetector in the optical head during the recording becomes very small. For this reason, the quality of a detection signal is remarkably deteriorated, and thus focus servo and tracking servo are occasionally disabled.

Therefore, the inventors of this application have already proposed the optical disc apparatus shown in FIG. 1 as an information recording/reproducing apparatus which superimposes a high-frequency signal between recording pulses so as to increase the average light amount, and performs recording using a sub-nano pulse and simultaneously executes the focus and tracking servo normally.

In the case where the recording pulses are generated by using the sub-nano pulse and the high-frequency signal is superimposed between the recording pulses, when a difference between a potential (current) level of the high-frequency signal continuous with the front and rear edges of the recording pulse and the desired start or end level of the recording pulse is large, unnecessary (unintended) relaxation oscillation might be generated in the semiconductor laser light source 20. When unnecessary relaxation oscillation is generated, irregularity occurs in the laser beam, and the recording mark is distorted so that a reproduction signal is also distorted.

Therefore, the high-frequency signal is superimposed between the recording pulses so that unnecessary relaxation oscillation is not generated.

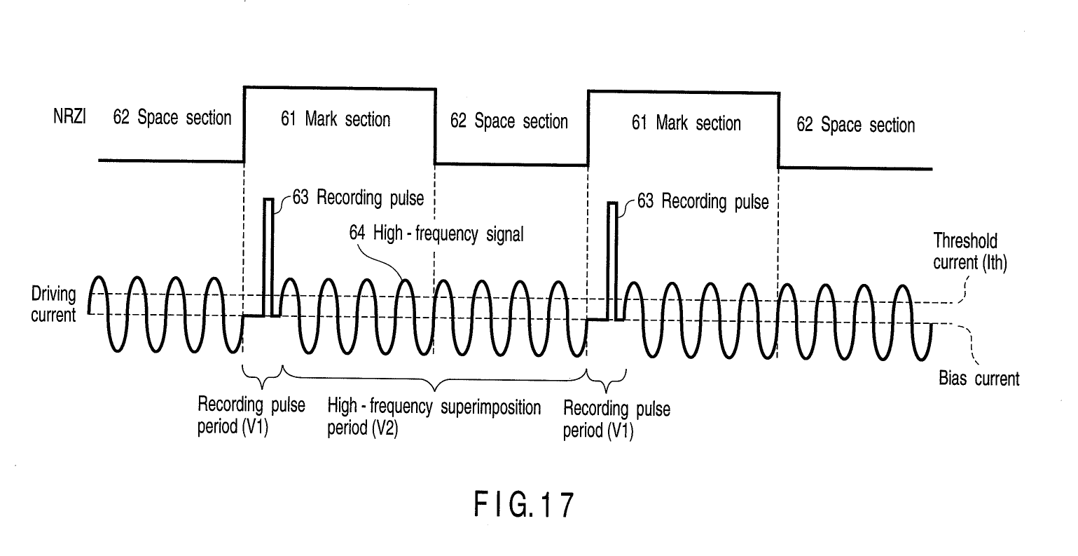

FIG. 17 is a diagram for explaining one example of a relationship between data to be recorded (NRZI) and a driving current waveform of a laser diode (LD) including the high-frequency signal in the “sub-nano pulse recording”. One or a plurality of recording pulses 63 is output on a mark portion 61. For periods other than a recording pulse period (V1), a high-frequency signal 64 is output regardless of the mark portion 61 and a space portion 62. As a result, average light intensity of the laser diode is maintained.

The semiconductor laser light source 20 emits light for the recording pulse period (V1) with stronger intensity than the light emission intensity at the high-frequency signal superimposition period (V2). This strong light emission causes a heat change on the recording layer of the optical disc, so that a recording mark is formed. The driving current at the high-frequency signal superimposition period (V2) has a value such that the average light intensity of the laser diode does not cause a heat or light change on the recording layer of the optical disc.

The light intensity at the high-frequency signal superimposition period (V2) is similar to the intensity at the time of reading information from the recording layer of the optical disc. The level of the threshold current shown in the drawing is a level near a boundary where the laser diode starts or stops emission of light. In order to obtain the relaxation oscillation, the recording pulse which steeply rises from the level of not more than the threshold current Ith is essential for the laser diode. Therefore, it is necessary for recording a mark to once securely reduce the current from a value for information reproduction to not more than the threshold, and then obtain the recording pulse 63 which steeply changes.

As shown in FIG. 17, a period for which the driving current is set to a bias current may be provided at the recording pulse period V1. In the recording using the sub-nano pulse, even when the driving current is set to 0 after the recording pulse 63, the light emission intensity is attenuated and simultaneously the light emission continues. A driving current constant bias period is provided after the recording pulse 63 until the relaxation oscillation is stopped, so that stable recording is enabled. The driving current shown in FIG. 17 is generated by adding a high-frequency superimposition circuit (not shown) to the circuit configuration in FIG. 1 and superimposing the high-frequency signal 64 on the semiconductor laser light source 20 from the high-frequency superimposition circuit.

The present invention is not limited to the above embodiments, and the components can be modified and embodied without departing from the principles disclosed herein. For example, the above embodiments describe the rewritable optical disc using the phase-change material as an example, but the present invention can be applied even to write once read many optical discs.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a light source configured to irradiate an optical disc with a laser beam;
a driving current supply configured to supply a driving current to the light source;
a determining module configured to control the driving current supply to carry out test writing on a recording layer of the optical disc with a light pulse of relaxation oscillation, configured to irradiate the test-written area with a reproduction laser beam, and configured to detect a reflected light from the optical disk in order to determine a write strategy based on the detected result; and
a recording module configured to record on the optical disc with the light pulse of relaxation oscillation based on the write strategy determined by the determining module.

2. The optical disc apparatus of claim 1, wherein a current pulse width of the driving current for generating the relaxation oscillation is shorter than or equal to 1.5 ns, and the write strategy comprises an optimal peak value and pulse width of the current pulse.

3. The optical disc apparatus of claim 2, wherein one of a plurality of continuous patterns comprising marks having time lengths between 6T and 13T, where T representing the length of one period of a reference clock, is written on the optical disc in the test writing, and the test-written area is irradiated with a laser beam, and the peak value of the current pulse is determined so that an amplitude of a detected signal based on reflected light of the laser beam has substantially increased.

4. The optical disc apparatus of claim 2, wherein a mixed pattern comprising one of marks and spaces from 6T to 13T and a mark and space of 2T is written on the optical disc in the test writing, and the pulse width of the current pulse is determined so that an asymmetry of a detected signal according to the reflected light becomes zero.

5. The optical disc apparatus of claim 2, wherein the determining module is configured to determine the pulse width of the current pulse so that a difference between a reproduction signal level on an unrecorded area and an amplitude center level of a detected signal at the time of using a continuous pattern 11T as a recording pattern is approximately twice as large as a difference between the reproduction signal on the unrecorded area and an amplitude center level of a detected signal at the time of using the continuous pattern of the shortest length mark 2T as a recording pattern.

6. The optical disc apparatus of claim 1, wherein the light source comprises a resonator, the length of the resonator is shorter than or equal to 3520 μm.

7. The optical disc apparatus of claim 1, wherein in the light pulse generated for the light source by the driving current supply comprises a full width at half maximum of a single pulse is shorter than or equal to 440 pico seconds (ps).

8. The optical disc apparatus of claim 1, wherein the determining module is configured to set a start value of a current pulse for generating the relaxation oscillation to a value smaller than an oscillation threshold of the laser beam, and a peak value of the current pulse is larger than the oscillation threshold.

9. The optical disc apparatus of claim 1, wherein the determining module is configured to control an output current of the driving current supply so that a maintaining time of the laser beam of the light pulse having the relaxation oscillation is shorter than or equal to 1.5 ns.

10. An optical disc processing method comprising:
irradiating a recording layer of an optical disc with a light pulse of relaxation oscillation by supplying a driving current to a laser light source in order to carry out test writing;
irradiating the test-written area with the laser beam in order to detect reflected light;
determining a write strategy based on the detected result of the reflected light; and
supplying the driving current based on the determined write strategy to the laser light source, and irradiating the recording layer of the optical disc with the light pulse of relaxation oscillation in order to execute a recording process.
